(19) United States
(12) Patent Application Publication
(10) Pub. No.: US 2018/0189721 A1
(43) Pub. Date: Jul. 5, 2018

(54) VENDING MACHINE HAVING SHELF LIFE MANAGEMENT FUNCTION AND DISCOUNT FUNCTION

(71) Applicant: Hanseung LEE, Suwon, Gyeonggi-do (KR)

(72) Inventor: Hanseung LEE, Suwon, Gyeonggi-do (KR)

(21) Appl. No.: 15/739,987

(22) PCT Filed: Jun. 30, 2016
(86) PCT No.: PCT/KR2016/006994

§ 371 Date: Dec. 27, 2017

(30) Foreign Application Priority Data
Jul. 1, 2015 (KR) 10-2015-0094290

(51) Int. Cl. G06Q 10/08; G06Q 20/38; G07F 9/02

(52) U.S. Cl. CPC G06Q 10/087; G07F 9/02; G06Q 20/38

(57) ABSTRACT

A vending machine includes: a shelf life setting unit configured to set a shelf life of a product; a shelf life information management unit configured to store and manage the shelf life of the product set by the shelf life setting unit; a shelf life expiration processing unit configured to check whether an end of the shelf life of the product stored in the shelf life management unit is upcoming, and to set the product to be unavailable for sale when the shelf life has expired; a discount setting unit configured to set at least one of a discount time point at which a discount is applied to a product, a discount method, and a discount condition to be satisfied for applying a discount method at the discount time point; and a discount processing unit configured to apply the discount method set by the discount setting unit.

### TECHNICAL FIELD

The present invention relates to a vending machine, and more specifically, a vending machine which has a function of setting and managing shelf life of a product to be sold, has a function of setting sales prohibition of a product which has reached a shelf life thereof, and discounts a price using various methods according to a discount time point and discount conditions set within the shelf life.

### BACKGROUND ART

A vending machine is a device that sells products to customers without any human intervention, and has been steadily expanding in various fields because of its advantages of a convenient sales process, drastically reducing labor and space costs caused by store maintenance, and ease of management.

Today, vending machines are used for various items such as tickets, beverages, snacks, favorite foods, disposable products, necessities, toys, books, and cosmetics, and are expected to maintain its solid position as a convenient distribution method in the future.

However, on the other hand, it is true that customers are concerned about or distrust products purchased from vending machines, and more worried especially when the products are food or drinks. One of the major issues that cause such concern or distrust is food safety, and thorough management of shelf life of materials and products, hygiene management, and maintenance of cleanliness in vending machine may be a solution for the issue.

If the safety of food or beverages sold by a vending machine is not guaranteed, the health and life of a customer who purchases a product may be put at risk, the customer may feel anxiety and dissatisfaction about the product, and a legal dispute, such as a lawsuit, may arise between the purchaser and a seller. As occurrences that raise the anxiety of potential customers or violates food safety are repeated, a vicious cycle of a drop or limitation in sales through vending machines and a downturn in related industries is inevitable.

In addition, in the case of products having a relatively short shelf life, frequent disposal of all products that have passed shelf life leads to business loss to sellers, and in the case of food, there is another problem of food waste disposal. Therefore, a more efficient method and system to ensure food safety and sell as many products as possible during a short shelf life are urgently required for a vending machine that sells products with relatively short shelf life.

As related arts on vending machines considering shelf life, Korean Patent No. 10-0988754, Korean Utility Model No. 20-0463577, Korean Utility Model No. 20-0352247, and the like are disclosed.

In Korean Patent No. 10-0988754, products corresponding to the same button (dispensed from the same loading box) may have different shelf lives, which may increase the burden of shelf life management, and since a sorting order and a dispensing order of products do not match with the order of shelf life of the products, products that have passed the shelf life may exist in the middle or back of the loading box, and hence there is a possibility of loss due to disposal of such products that failed to be sold in time.

In Korean Utility Model No. 20-0463577, a product which has passed shelf life is prevented from being sold only after a customer presses a selection button for a desired product. Thus, a product is displayed as being present in a vending machine, such that there is a possibility that the customer is not able to purchase a specific product even when pressing a product selection button because there is no product within its shelf life.

Korean Utility Model No. 20-0352247 limits its application target to canned beverages and allows shelf life to be arbitrarily extended, thereby leaving room for manipulating or falsifying the shelf life by an administrator of a vending machine.

As related arts on vending machines having a discount sales function, Korean Patent No. 10-0993833, Korean Patent Application No. 10-1998-0008337, and the like are disclosed.

The former patent relates to an invention designed to receive event information from a server and store the event information, and provide related information to a customer when a product selected by a customer is a target event item. Since the server controls all discount events, there is a limitation in that it is not possible to carry out independent discount policies according to sales situations that differ from one vending machine to another. Also, a specified processing method for selling products at a discounted price to a customer who has received related information (e.g., changing an original product price to a discounted price, displaying the discounted price, comparing an inserted amount and the product price, calculating the change amount reflecting the discounted price, and the like) is not disclosed.

The latter patent aims at raising the sales of vending machine by inducing customers' interest by discounting sales price and showing a congratulatory message when the preset number of sales is reached. However, in the case of a vending machine selling food, especially food with very short life time (e.g., bread, rice cakes, sushi, rice balls, etc.), when all products cannot be sold before shelf life expires on the same day or within a few days, a large loss may be incurred and disposal of waste such as food waste that burdens the environment is inevitable, and in this regard, a more serious and effective discount method, rather than that of an event or interest-oriented discount, is needed. In addition, discounting the tenth or one-hundredth order cannot be helpful in a situation in which a large quantity of unsold inventory may remain.

### DISCLOSURE

### Technical Problem

For a vending machine that sells food or beverages, thorough shelf life management is essential. In the case of products with shelf life expiring on the same day or within a few days or products having a relatively short shelf life (e.g., bread, rice cakes, sushi, rice balls, fruits, vegetables, fish, products made of natural materials), if the entire quantity is not sold within a very short shelf life, large business loss may be incurred, and since it is inevitable to dispose of waste such as food waste which is burdensome to the environment, there is a need for exhausting as much amount as possible during the shelf life through more active inventory management and sales policies.

An objective of the present invention is to provide a systematic shelf life management method for a vending machine selling products with relatively short shelf life, such as food or products made of natural materials, which enhances food safety and allows customers to purchase the products at ease.

In addition, another objective of the present invention is to minimize the amount of waste, such as food waste, and business loss incurred due to products which do not sell well until shelf life thereof is reached, and as well as to increase sales of operators by inducing customers to buy products within their shelf life through discounting product prices using various methods.

### Technical Solution

One aspect of the present invention provides a vending machine which sells products with a relatively short shelf life, such as food and products using natural materials, the vending machine including: (1) a shelf life setting unit configured to set a shelf life of a product; (2) a shelf life information management unit configured to store and manage the shelf life of the product set by the shelf life setting unit; and (3) a shelf life expiration processing unit configured to check whether the end of the shelf life of the product stored in the shelf life management unit is upcoming and to set the product to be unavailable for sale when the shelf life has expired so that hygiene and food safety can be guaranteed for customers purchasing a product from a vending machine.

In addition, for selling, at discounted prices, products that lead to large business loss if the products are not all sold during the relatively short shelf lives thereof, (4) a discount setting unit and (5) a discount processing unit are added.

Moreover, in order to perform an additional discount when products do not sell well, (6) an inventory quantity information management unit configured to identify and manage a quantity of product inventory in real time, (7) an additional discount setting unit configured to set a quantity of inventory (hereinafter referred to as a “reference quantity of inventory”), which is a basis of an additional discount, and to set a discount method to be additionally applied when a quantity of inventory at a specific time point is equal to or greater than the reference quantity of inventory, and (8) an additional discount processing unit configured to apply the discount method set by the additional discount setting unit when the quantity of inventory at the specific time point is equal to or greater than the reference quantity of inventory are added.

Further, in order to completely exhaust even a small amount of inventory even in a case where the products sell well, (9) a remnant sale setting unit configured to set a reference quantity of inventory for enabling a remnant sale when a quantity of inventory is less than or equal to a specific quantity, and to set a discount method to be applied to the remnant sale when the quantity of inventory at a specific time point is less than or equal to the reference quantity of inventory and (10) a remnant sale processing unit configured to apply the discount method set by the remnant sale setting unit when the quantity of inventory at the specific time point is less than or equal to the reference quantity of inventory are added.

### Advantageous Effects

Advantageous effects of the present invention are as follows:

First, by providing a function enabling thorough management of shelf life, it is possible to improve food hygiene and safety.

Second, it is possible to relieve concerns of customers who buy products from a vending machine and minimize complaints after purchase.

Third, by allowing customers to buy products from the vending machine at ease, it is possible to contribute to sales growth of vending machine operators.

Fourth, by inducing customers to buy a product by discounting the product's price in various ways within shelf life, it is possible to minimize loss caused by disposal of products that have passed their shelf life and reduce the amount of waste such as food waste.

### DESCRIPTION OF DRAWINGS

FIG. 1 is a diagram illustrating an example of a general vending machine.

FIG. 2 is a representative diagram of the present invention.

FIG. 3 is a diagram illustrating an embodiment of a product to be sold by a vending machine according to the present invention and various buttons located below the product.

FIG. 4 is a diagram showing an example of shelf life setting.

FIG. 5 is a diagram showing an example of a method of discount set within shelf life.

FIG. 6 is a diagram illustrating an embodiment in which the discount method is applied according to the arrival of the discount time point set in FIG. 5.

FIG. 7 is a diagram illustrating an embodiment of a bonus discount (N+M).

FIG. 8 is a diagram illustrating an example of setting a discount method when purchase is made over a specific amount or quantity.

FIG. 9 is a diagram illustrating an embodiment in which a discount method is applied only when an inventory quantity is equal to or greater than a reference quantity of inventory.

FIG. 10 is a diagram illustrating an embodiment in which an additional discount is applied when an inventory quantity is equal to or greater than a reference quantity of inventory.

FIG. 11 is a diagram illustrating an embodiment of a remnant sale.

FIG. 12 is a diagram illustrating an embodiment in which a remnant sale is carried out only when an inventory quantity is less than or equal to a reference quantity of inventory for the remnant sale, regardless of a discount time point.

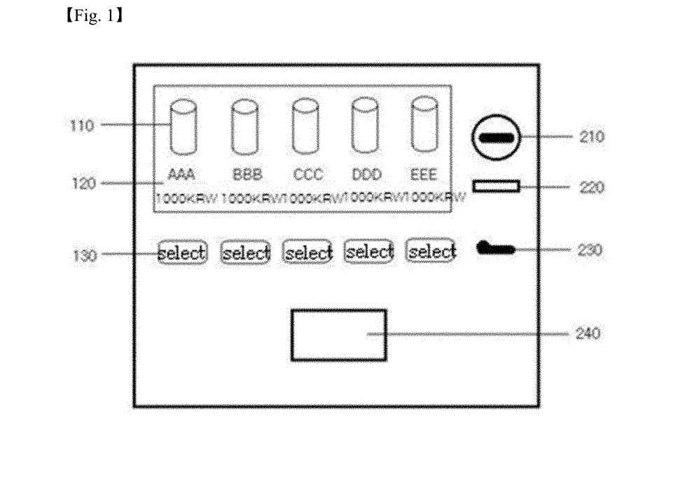

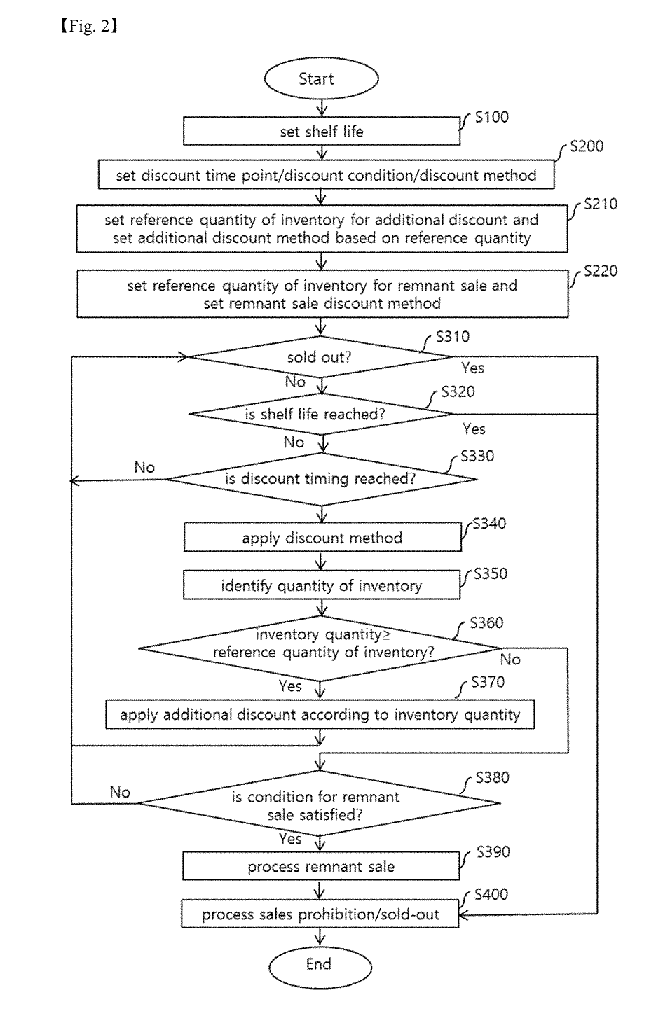

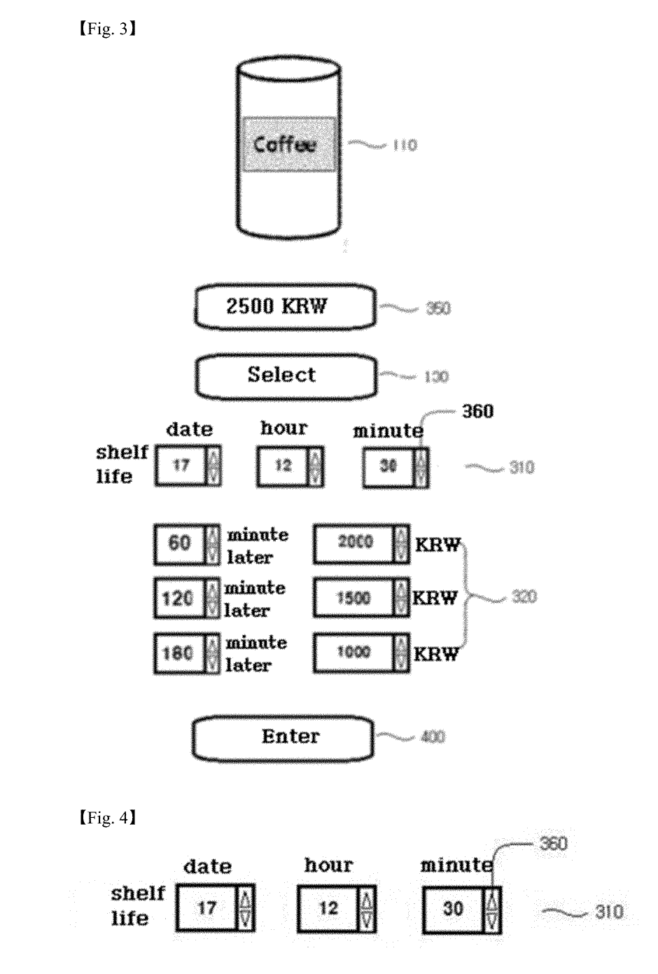

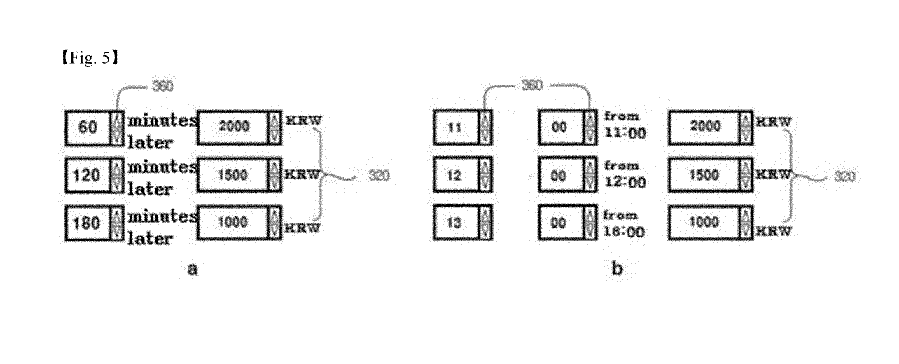

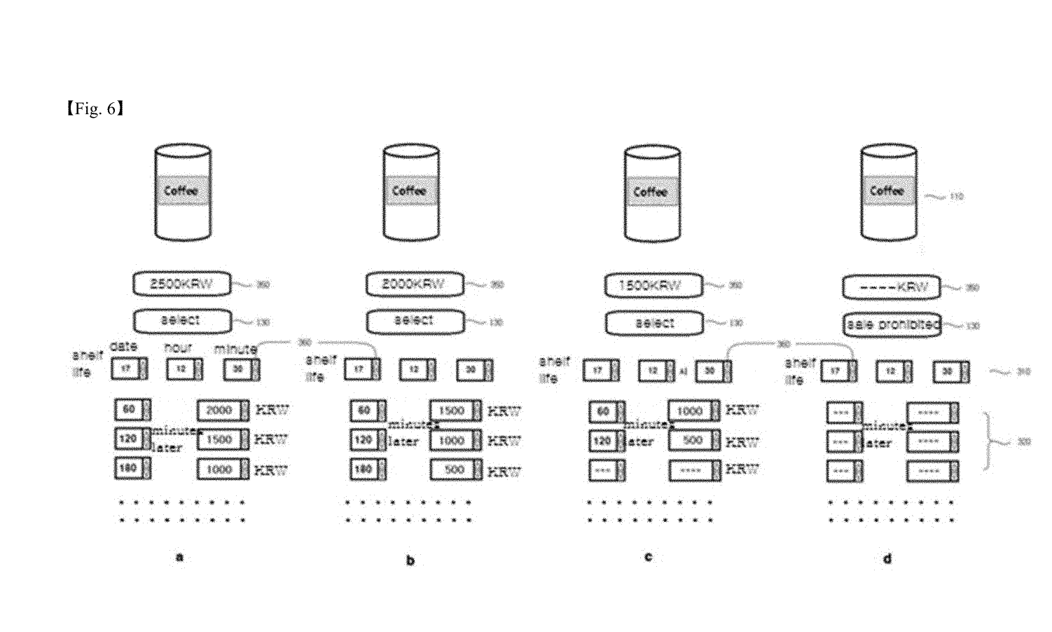

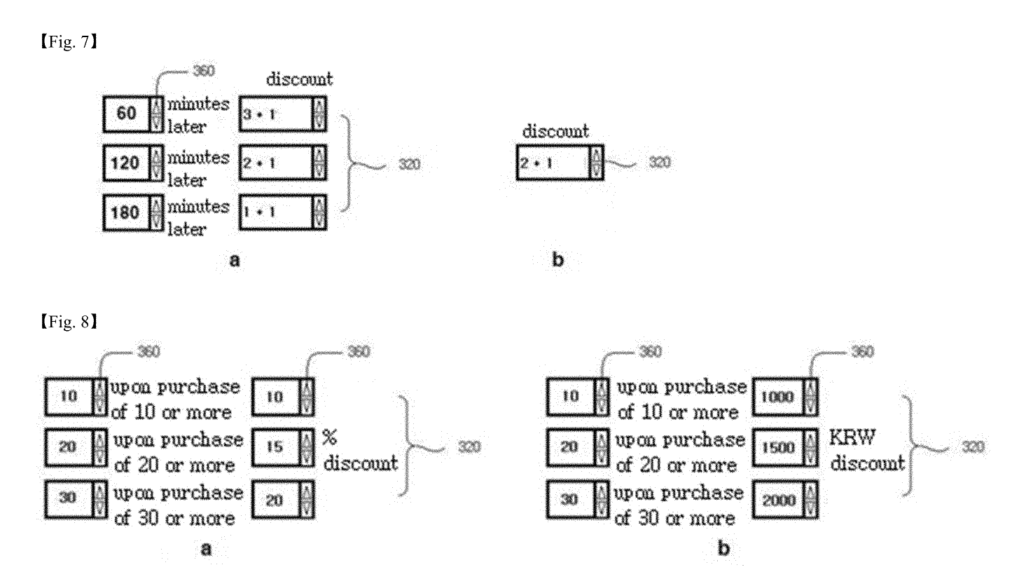

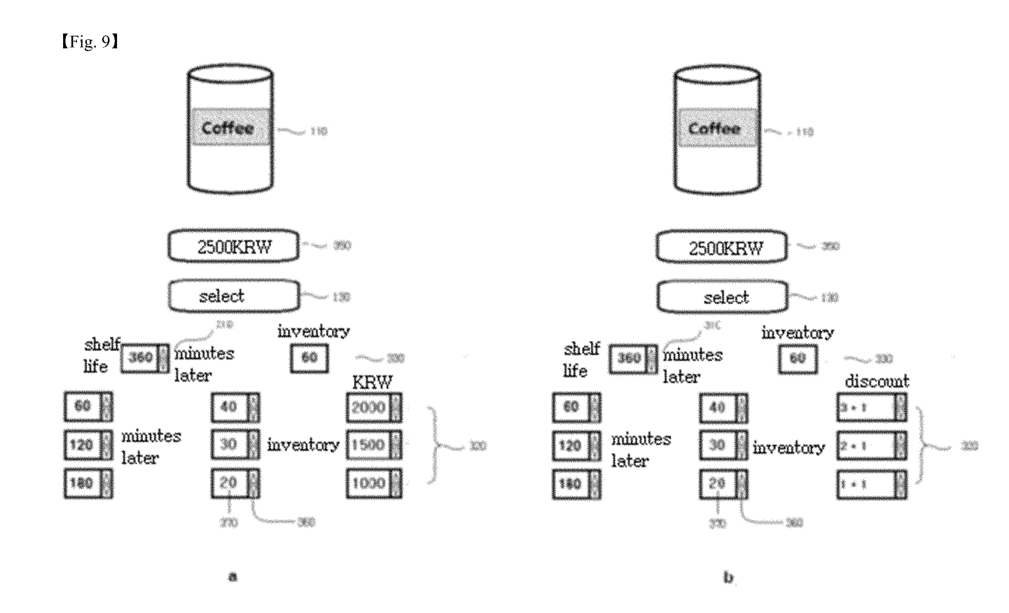

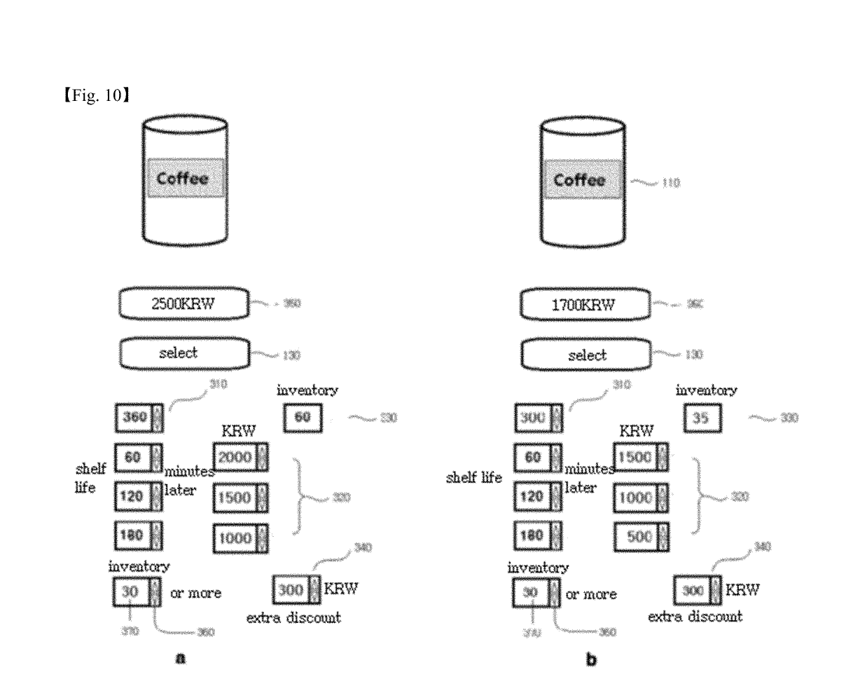

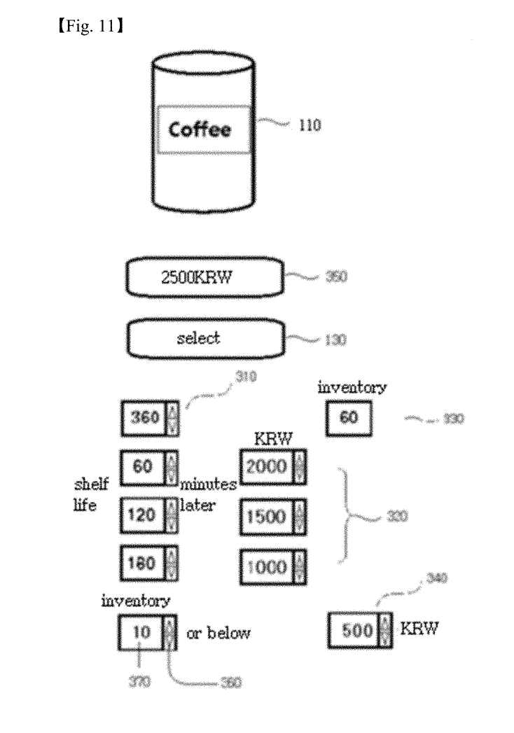

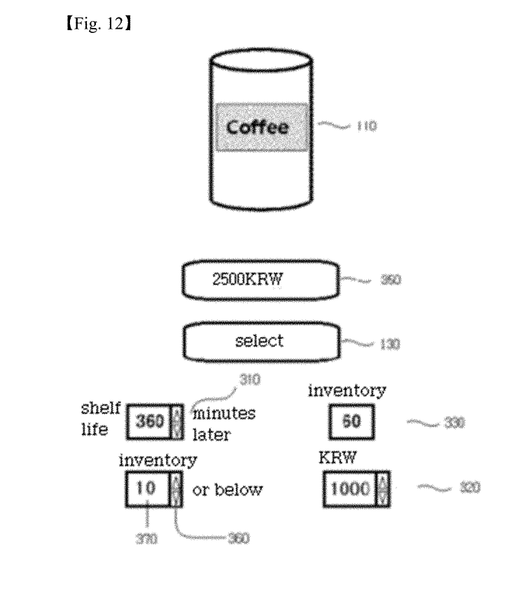

### BEST MODES OF THE INVENTION

Best modes for carrying out the present invention are described in claims 1 and 4 below.

As described in claim 1, the most preferable vending machine configured according to the present invention includes: (1) a shelf life setting unit configured to set a shelf life of a product; (2) a shelf life information management unit configured to store and manage the shelf life of the product set by the shelf life setting unit; (3) a shelf life expiration processing unit configured to check whether the end of the shelf life of the product stored in the shelf life management unit is upcoming, and to set the product to be unavailable for sale when the shelf life has expired; (4) a discount setting unit configured to set at least one of a discount time point at which a discount is applied to a product, a discount method, and a discount condition to be satisfied for applying a discount method at the discount time point; and (5) a discount processing unit configured to apply the discount method set by the discount setting unit.

The configuration of claim 1 is described stepwise in claim 4, and another mode of the most preferable vending machine configured according to the present invention includes: (1) a shelf life setting operation for setting a shelf life of a product; (2) a shelf life information management operation for storing and managing the shelf life of the product set in the shelf life setting operation; (3) a shelf life expiration processing operation for checking whether the shelf life of the product stored in the shelf life management unit will expire soon, and for setting the product to be unavailable for sale when the shelf life has expired; (4) a discount setting operation for setting at least one of a discount time point at which a discount is applied to a product, a discount method, and a discount condition to be satisfied for applying a discount method at the discount time point; and (5) a discount processing operation for applying the discount method set by the discount setting unit. The specific elements of claims 1 and 4 may be substantially the same.

### MODES FOR THE INVENTION

### Embodiment 1

In order to offer an additional discount when the quantity of product inventory is equal to or greater than a reference quantity even if the shelf life of the product is imminent, a vending machine configured according to the present invention may further include, in addition to the configuration of claim 1; (1) an inventory quantity information management unit configured to identify and manage an inventory quantity of products in real time; (2) an additional discount setting unit configured to set a reference quantity of inventory for offering an additional discount when the quantity of inventory is equal to or greater than the reference quantity, and configured to set a discount method to be additionally applied when a quantity of inventory at a specific time point is equal to or greater than the reference quantity of inventory; and (3) an additional discount processing unit configured to apply the discount method set by the additional discount setting unit when the quantity of inventory at the specific time point is equal to or greater than the reference quantity of inventory, as described in claim 2.

### Embodiment 2

In order to enable a remnant sale when a quantity of inventory is less than or equal to a reference quantity, the vending machine further includes, in addition to the configuration of claim 1, (1) an inventory quantity information management unit configured to identify and manage a quantity of product inventory in real time; (2) a remnant sale setting unit configured to set a reference quantity of inventory for enabling a remnant sale when a quantity of inventory is less than or equal to a specific quantity, and to set a discount method to be applied to the remnant sale when the quantity of inventory at a specific time point is less than or equal to the reference quantity of inventory; and (3) a remnant sale processing unit configured to apply the discount method set by the remnant sale setting unit when the quantity of inventory at the specific time point is less than or equal to the reference quantity of inventory, as described in claim 3.

The above embodiments are configurations further comprising the configuration of claim 2 or claim 3 in addition to the configuration of claim 1. With respect to claim 4, configurations of claims 5 and 6 correspond to the configurations of claims 2 and 3, respectively.

### INDUSTRIAL APPLICABILITY

A vending machine according to the present invention in which a thorough shelf life management function and various discount functions are added to an existing vending machine may be implemented to (1) ensure food safety for food or beverages of which thorough shelf life management is vital, and (2) reduce business loss which may be incurred when the entire quantity of products fail to be sold during a very short shelf life thereof in the case of products having a relatively short shelf life (e.g., bread, rice cakes, sushi, rice balls, fruits, vegetables, fish, products made of natural materials) and minimize the amount of discharged food waste and the like.

Therefore, through the implementation of the present invention, it is possible to respond to customers' needs for food safety, reduce loss of operators while maximizing sales, and reduce environmental burdens by exhausting the inventory as much as possible. By responding to social/national needs, the vending machine of the present invention has sufficient business value and industrial applicability.

In addition, various discount methods of the present invention may be implemented with a simple and effective user interface (UI), as described with reference to the drawings of the present invention, and a specific processing method may be implemented using a method, such as microprogramming, which is available for business use and sales.

1. A vending machine comprising:
a shelf life setting unit configured to set a shelf life of a product;
a shelf life information management unit configured to store and manage the shelf life of the product set by the shelf life setting unit;
a shelf life expiration processing unit configured to check whether an end of the shelf life of the product stored in the shelf life management unit is upcoming, and to set the product to be unavailable for sale when the shelf life has expired;
a discount setting unit configured to set at least one of a discount time point at which a discount is applied to a product, a discount method, and a discount condition to be satisfied for applying a discount method at the discount time point; and
a discount processing unit configured to apply the discount method set by the discount setting unit.

2. The vending machine of claim 1, further comprising:
an inventory quantity information management unit configured to identify and manage an inventory quantity of products in real time;
an additional discount setting unit configured to set a reference quantity of inventory for offering an additional discount when the quantity of inventory is equal to or greater than the reference quantity and configured to set a discount method to be additionally applied when a quantity of inventory at a specific time point is equal to or greater than the reference quantity of inventory; and
an additional discount processing unit configured to apply the discount method set by the additional discount setting unit when the quantity of inventory at the specific time point is equal to or greater than the reference quantity of inventory.

3. The vending machine of claim 1, further comprising:
an inventory quantity information management unit configured to identify and manage a quantity of product inventory in real time;
a remnant sale setting unit configured to set a reference quantity of inventory for enabling a remnant sale when a quantity of inventory is less than or equal to a specific quantity, and to set a discount method to be applied to the remnant sale when the quantity of inventory at a specific time point is less than or equal to the reference quantity of inventory; and
a remnant sale processing unit configured to apply the discount method set by the remnant sale setting unit when the quantity of inventory at a specific time point is less than or equal to the reference quantity of inventory.

4. A product discount method for a vending machine, comprising:
a shelf life setting operation for setting a shelf life of a product;
a shelf life information management operation for storing and managing the shelf life of the product set in the shelf life setting operation;
a shelf life expiration processing operation for checking whether the shelf life of the product stored in the shelf life management unit will expire soon, and for setting the product to be unavailable for sale when the shelf life has expired;
a discount setting operation for setting at least one of discount time point at which a discount is applied to a product, a discount method, and a discount condition to be satisfied for applying a discount method at the discount time point; and
a discount processing operation for applying the discount method set by the discount setting unit

5. The product discount method of claim 4, further comprising:
an additional discount setting operation for setting a reference quantity of inventory for offering an additional discount and for setting a discount method to be additionally applied when a quantity of inventory at a specific time point is equal to or greater than the reference quantity of inventory; and
an additional discount processing operation for applying the discount method set by the additional discount setting unit when the quantity of inventory at the specific time point is equal to or greater than the reference quantity of inventory.

6. The product discount method of claim 4, further comprising:
a remnant sale setting operation for setting a reference quantity of inventory for enabling a remnant sale and for setting a discount method to be applied to the remnant sale when the quantity of inventory at a specific time point is less than or equal to the reference quantity of inventory; and
a remnant sale processing operation for applying the discount method set by the remnant sale setting unit when the quantity of inventory at the specific time point is less than or equal to the reference quantity of inventory.

7. The vending machine of claim 1, wherein the discount method is one of discount price application, discount rate application, discount range application, bonus discount, gift discount, discount when purchase is over a reference price amount, discount when purchase is over a reference quantity, and discount based on a reference inventory quantity.

8. The product discount method of claim 4, wherein the discount method is one of discount price application, discount rate application, discount range application, bonus discount, gift discount, discount when purchase is over a reference price amount, discount when purchase is over a reference quantity, and discount based on a reference quantity of inventory.
